(19) United States
(12) Patent Application Publication
(10) Pub. No.: US 2012/0089484 A1
(43) Pub. Date: Apr. 12, 2012

(54) Methods, Devices, and Computer Program Product for Offering Media Content Based on User Preferences

(76) Inventors: Shiv Kumar, Marlboro, NJ (US); James Gordon Beattie, JR., Bergenfield, NJ (US); Soumyajit Chakraborty, Harrison, NJ (US)

(21) Appl. No.: 12/900,731

(22) Filed: Oct. 8, 2010

(51) Int. Cl. G06Q 30/00; G06Q 40/00; G06F 15/16

(52) U.S. Cl. 705/26.61; 709/219; 705/40

(57) ABSTRACT

Media content is offered upon indication of receipt of a communication from a first communication device to a second communication device. A sample of media content is transmitted to the first communication device or the second communication device based on at least one preference of a user of the first communication device or the second communication device. A selection is received from the first communication device or the second communication device, indicating whether a user of the first communication device or the second communication device desires to download the media content based on the sample. If the received selection indicates that the user of the first communication device or the second communication device desires to download the media content, the media content is transmitted to the first communication device, the second communication device, or another designated device

### TECHNICAL FIELD

The present disclosure relates generally to telecommunications, and, more particularly, to offering media content.

### BACKGROUND

Media content providers provide an array of media content to users, based on user selections. Typically, a user selects media content from a media guide, and the media content provider provides the selected media content to the user via a telecommunications connection.

A user may refer to media content reviews posted by other users in selecting media content. However, the reviews of other users are not typically geared towards any particular user and thus may not be relevant. Moreover, there is little incentive for users to provide reviews of media content or to suggest media content to any particular user.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the disclosure.

According to one embodiment, a method for offering media content includes performing at least one of a first media content offering and a second media content offering responsive to receipt of an indication of a communication from a first communication device to a second communication device. The first media content offering includes transmitting a first media content sample of first media content to the first communication device or the second communication device based on at least one preference of a user of the first communication device or the second communication device and receiving a selection from the first communication device or the second communication device indicating whether a user of the first communication device or the second communication device desires to download the first media content based on the first media content sample. If the received selection from the first communication device or the second communication device indicates that the user of the first communication device or the second communication device desires to download the first media content, the first media content is transmitted to the first communication device, the second communication device, or another designated device.

According to another embodiment, a device for offering media content, includes a transceiver for communicating with at least a first communication device and a second communication device, a memory for storing at least one user preference associated with a user of the first communication device and at least one user preference associated with a user of the second communication device, and a processor for offering media content based on the stored user preferences. Responsive to an indication of a communication from the first communication device to the second communication device, the processor performs at least one of a first media content offering and a second media content offering. The first media content offering includes transmitting a first media content sample of first media content to the first media communication device or the second communication device based on at least one preference of a user of the first communication device or the second communication device and receiving a selection from the first communication device or the second communication device indicating whether a user of the first communication device or the second communication device desires to download the first media content based on the first media content sample. If the received selection from the first communication device or the second communication device indicates that the user of the first communication device or the second communication device desires to download the first media content, the first media content is transmitted to the first communication device, the second communication device, or another designated device.

According to another embodiment, a non-transitory computer program product includes a storage medium upon which instructions are recorded that, when executed by a processor, perform a method for offering media content. The method includes performing at least one of a first media offering and a second media content offering, responsive to receipt of an indication of a communication from a first communication device to a second communication device, transmitting a first media content sample of first media content to the first communication device or the second communication device based on at least one preference of a user of the first communication device or the second communication device and receiving a selection from the first communication device or the second communication device indicating whether a user of the first communication device or the second communication device desires to download the first media content based on the first media content sample. If the received selection from the first communication device or the second communication device indicates that the user of the first communicating device or the second communication device desires to download the first media content, the first media content is transmitted to the first communication device, the second communication device, or another designated device

### BRIEF DESCRIPTION OF THE DRAWINGS

FIG. 1 illustrates an exemplary environment in which media content is offered according to an exemplary embodiment

FIG. 2A illustrates a call flow scenario in which media content is offered to a called party device according to an exemplary embodiment.

FIG. 2B illustrates a call flow scenario in which media content is offered to a calling party device according to an exemplary embodiment.

FIG. 3A illustrates an exemplary method for offering media content to a called party device according to an exemplary embodiment.

FIG. 3B illustrates an exemplary method of offering media content to a calling party device according to an exemplary embodiment.

FIG. 4 illustrates an exemplary device for offering media content according to an exemplary embodiment.

### DETAILED DESCRIPTION

Detailed exemplary embodiments are disclosed herein. It must be understood that the embodiments described and illustrated are merely examples that may be embodied in various and alternative forms, and combinations thereof. As used herein, the word “exemplary” is used expansively to refer to embodiments that serve as examples or illustrations. The figures are not necessarily to scale and some features may be exaggerated or minimized to show details of particular components. Specific structural and functional details disclosed herein are not to be interpreted as limiting.

According to exemplary embodiments, wireless and wireline users are enabled to associate media and other preferences for products and services for each number, e.g., telephone number, on their accounts and for some or all called numbers. Preferences may include, e.g., preferences for particular music genres, artists, movies, books, event tickets, and other products and services. Preferences may be designated using, for example, calling party/called party devices and/or a web portable or any other device accessible by users of the calling party/called party devices to set preferences.

According to exemplary embodiments, when a call is made, one or more songs, ring tones, and offers for products/services may be played to the called party and/or to the calling party. Thus, media offerings may be sent in either or both directions between the called party and the calling party.

The called party and the calling party may be provided with a real time offer to purchase and download media content, such as a complete song, a ringtone, a movie, a music video, a book, an event tickets or other products/services, before the call setup is terminated or at any point during the actual call. If downloading occurs during a call, it is desirable that it not interfere with the call, e.g., the speech path. Alternatively, the called party and the calling party may be provided with an offer to purchase and download media content after completion of the call, e.g., by maintaining an offer history. The media content may be downloaded to a device used for the call, e.g., a cellular telephone, or another designated device, e.g., another device that may be used for playing the media or a server hosting a media account, such as an I-Tunes account. Preferences for downloading media content to other devices may be designated by users in a manner similar to which media preferences are designated for a calling party and a called party. The media content may be downloaded at any desired point, e.g., during the actual call, upon completion of the call, or at any point after completion of the call. In addition, or as an alternative, a history of purchased media content may be stored in a user's library for future downloads. A called party/calling party may also purchase media contest using a call history of previously played ring tones through the use of, e.g., a handheld computer or media device.

According to an exemplary embodiment, an offer may be forwarded to a called party/calling party's friends and associates, and if a friend or associate downloads the offered media, the called party/calling party may be credited to his or her account for that download. This provides an incentive for the called party/calling party to refer offers to others.

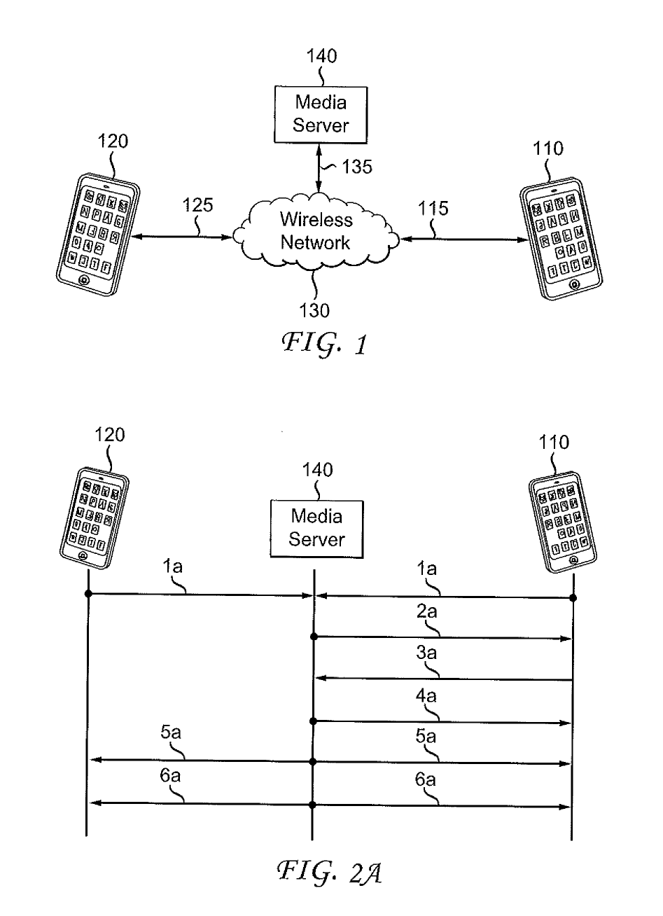

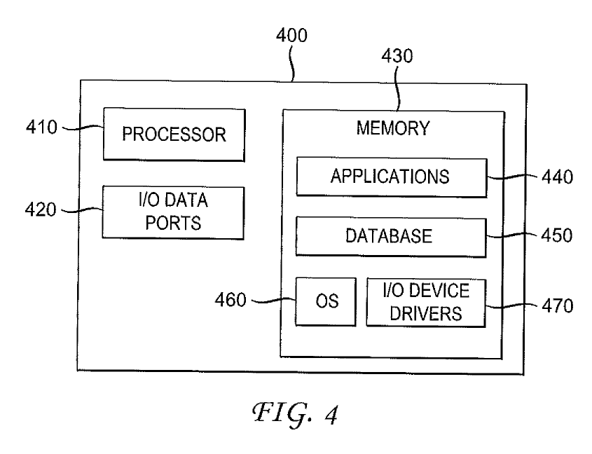

FIG. 1 illustrates an environment in which media offers may be made to users based on user preferences according to an exemplary embodiment. In FIG. 1, a called party's device is represented as a wireless device 110. A calling party's device is presented as a wireless device 120. It should be appreciated that the calling party's device 120 and the called party's device 110 may be implemented with any suitable device for receiving media content, including but not limited to a cellular telephone, a personal digital assistant (PDA), etc. According to an exemplary embodiment, the devices 110 and 120 communicate wirelessly through a network 130 via wireless connections 115 and 125, respectively. The network 130 may be implemented with any suitable wireless network for transmitting media content, including but not limited to a cellular network, a wireless Internet, etc. The network 130, in turn, communicates with a media server 140 via a wireless connection 135. The wireless connections 115, 125, and 135 may be implemented with any suitable connections, including but not limited to RF connections, WIFI connections, etc. Further, the devices 110 and 120 may be wireline devices, and the network 130 may be a wireline network, in which case the connections 115, 125 and 135 may include any suitable wireline connections. The media server 140 may be implemented with a device such as that described with reference to FIG. 4 below.

According to one embodiment, the calling party using a calling device 120 drives the process of a random content sale opportunity to the called party using the called device 110, based on preferences of the calling party that are stored in advance in the media server 140. The calling party may store preferences specifically geared toward the called party, among others. The calling party preferences may be overridden by preferences of the called party. If the called party accepts an offer to purchase media, products, or services based on the calling party's recommendation, the calling party's account may be credited.

According to another embodiment, the called party using device 110 may specify media preferences that are stored in advance in the media server 140. Alternatively, there preferences may be specified via other suitable devices, e.g., a web portal accessible via a personal computer or PDA. The calling party may be offered media based on the preferences of the called party. The called party's preferences may be geared to the calling party, among others. If the calling party accepts an offer to purchase media, product, or service based upon the called party's recommendation, the called party's account may be credited.

The media server 140 stores preferences, including, for example, songs, ring tones, music, and video preferences for each telephone number. The media server 140 interfaces with users via the wireless network 130 for preference management and purchase history. The media server 140 streams media content that is selected by called parties/calling parties to the desired destinations and stores balances of credits/debits for all parties. The media server 140 acts as a media store, allowing users to purchase media content in real time. Also, users may be provided with a message, e.g., a text message or an email, providing a URL which may be used to purchase items at a later date. Additionally, a listing of offers may be stored, e.g., in the media store 140 or in the devices 120 and 110, allowing users to purchase offer media content at a later date.

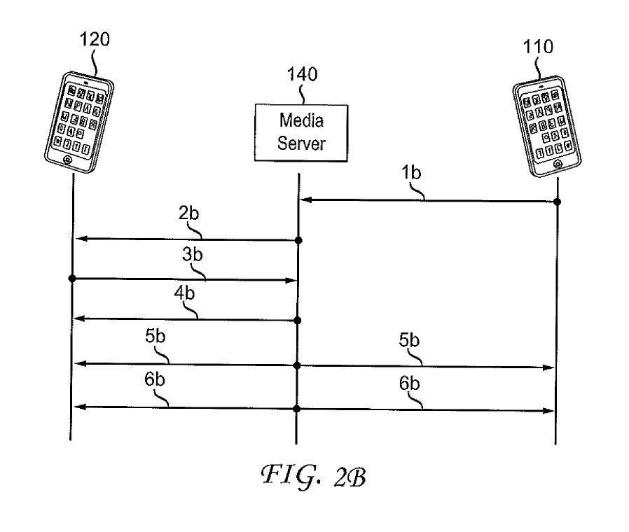

FIG. 2A illustrates a call flow scenario in which a called party is offered media content according to an exemplary embodiment. In this figure and in FIG. 2B that follows, the network 130 and the connections 115, 125, and 135 are omitted for simplicity of illustration. Referring to FIG. 2A, the calling party and the called party select media preferences, and the preferences are uploaded to the media server 140 via the devices 120 and 110, respectively, or a web portal. This is represented in FIG. 2A with reference numeral 1a. When a called party receives a call, the media server 140 pushes a sample of media content, e.g., a music sample, music video sample, etc., based on the preferences of the calling party and/or the called party, to the called party device 110. This is represented in FIG. 2A as reference number 2a. The pushed media sample is played on the called party device 110, e.g., as a ring tone, to alert the called party of the call. The ring tone may be a short commercial blurb with an offer to the called party. According to an exemplary embodiment, the media server 140 keeps a record of already purchased music and other media and only pushes media content samples that the called party has not already purchased or previously rejected. Also, the media server 140 may override the calling party's preferences based on the account settings of the called party.

According to an exemplary embodiment, the called party may select media to purchase, based on the media content sample, e.g., through pushing buttons on a keyboard of the called party device 110. For example, the called party may push “S” to purchase a song, “R” to purchase a ring tone, “B” to purchase a book, “mm” for a multi-media package, and “X” not to purchase. The selections made via the called party device 110 are communicated to the media server 140, as represented in FIG. 2A by reference numeral 3a. If “X” is not selected, the media server 140 passes the selected media selection to the called party device 110 or to one or inure other locations designated by the called party, e.g., at the end of the call, as represented by reference numeral 4a. Alternatively, the called party device 110 may be sent a message including, e.g., a URL, which may be used at a later date to purchase and download the selected media content. Additionally, a listing of offered media content may be stored such that media content may be purchased at a later date. The media server 140 sends a notification message, e.g., a text message and/or an email, to the called party device 110 and the calling party device 120 indicating that the selection has been downloaded to the called party's device 110 or another designated location, as represented by reference numeral 5a. The media server 140 updates the accounts of the called and calling parties, as represented in FIG. 2A with reference numeral 6a

According to an exemplary embodiment, the calling party's account may be Credited, and the called party's account may be billed for a download, if the called party downloads the media content. Alternatively, the media content may be free, in which case the called party's account would not be billed. Additionally, if the called party and/or the calling party recommend the media content to others, the accounts of the called party and/or the calling party may be credited, and the accounts of others may be billed, as appropriate. Credit may be in the form of money, bonus points, and/or loyalty credits which may be used for other purchases or for obtaining discounts. Accounts may be billed in a similar manner, e.g., by subtracting money, bonus points, and/or loyalty credits from a party's account.

FIG. 2B illustrates a call flow scenario in which a calling party is offered media content according to an exemplary embodiment. Referring to FIG. 2B, the called party chooses media content to offer to a calling party by storing preferences in advance in the media server 140. This is represented in FIG. 2B as reference numeral lb. The media content may include, e.g., a tune. The called party's selected media content to play to a calling party is marked in the media server 140. The calling party may also store preferences for media content in the media server 140. These preferences may override those preferences of the called party. Upon receipt of an incoming call from the calling party device 120 to the called party device, the media server pushes a sample of the called party's selected media content, as represented in FIG. 2B by reference numeral 2b. The calling party may choose to download the media content based on the media content sample, e.g., the entire song or a ring tone associated with the played tune, as represented by reference numeral 3b in FIG. 2B. The calling party's selections may be communicated to the media server 140 before the calling party device 120 is connected to the called party device 110. The calling party's selections may be made in a manner similar to that described for the called party's selections above with reference to FIG. 2A.

According to an exemplary embodiment, the media server 140 downloads the selected media content, e.g., after the call is completed, to the calling party device 120 as represented in FIG. 2B by reference numeral 4b. Alternatively, the calling party device 120 may be sent a message including, e.g., a URL, which may be used at a later date to purchase and download the selected media content. Additionally, a listing of offered media content may be stored such that media content may be purchased at a later date. The media server 140 may send a notification message, e.g., a text message or an email, to the called party device 110 and the calling party device 120, indicating that the selected media has been purchased and downloaded, as represented by reference numeral 5b in FIG. 2B. The media server 140 updates the accounts of the called and calling parties, as represented in FIG. 2B with reference numeral 6b.

According to an exemplary embodiment, the called party's account may be credited, and the calling party's account may be billed for a download, if the calling party downloads the media content. Alternatively, the media content may be free, in which case the calling party's account would not be billed. Additionally, if the called party and/or the calling party recommend the media content to others, the accounts of the called party and/or the calling party may be credited, and the accounts of others may be billed, as appropriate. Crediting and billing may be performed in a manner similar to that described above with reference to FIG. 2A.

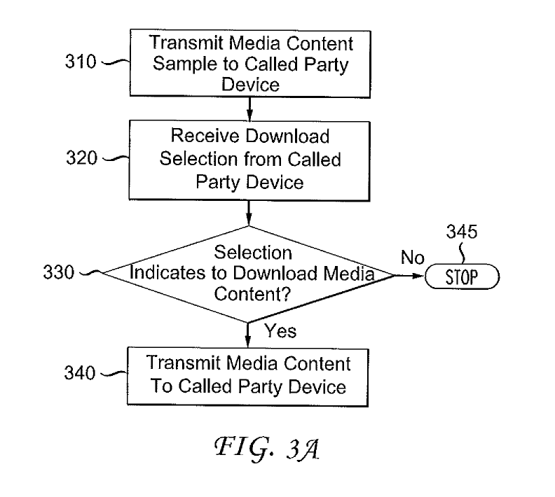

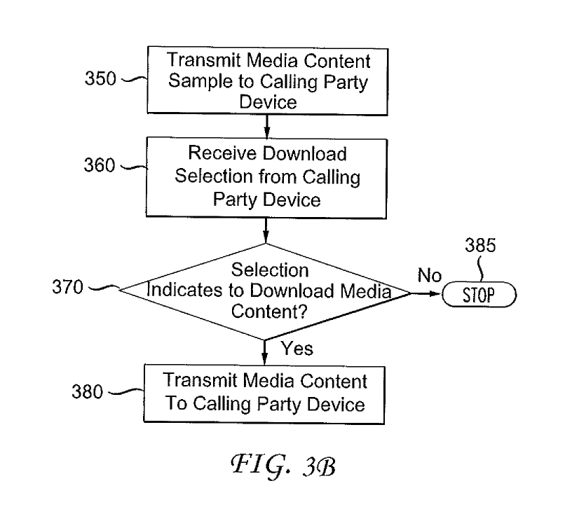

FIG. 3A illustrates a method for providing media content to a called party according to an exemplary embodiment. At step 310, responsive to receipt of an indication of a communication from a calling party device, such as device 120, to a called party device, such as device 110, and before termination of the communication from the calling party device and the called party device, a media content sample of media content is transmitted from the media server 140 to the called party device 120 via the network 130 based on at least one preference of the calling party. The media content sample may also be transmitted based on a user preference of the called party, which may override the preference of the calling party. At step 320, a selection from the called party indicating whether the called party desires to download the media content based on the media content sample is received the media server 140 via the network 130. A determination is made at step 330, e.g., by the media server 140, whether the received selection from the called party device 110 indicates that the called party desires to download the media content. If the received selection indicates that the called party desires to download the media content, the media content is transmitted at step 340 from the media server 140 to the called party device 110 via the network 130. Alternatively, the media content may be delivered to any other device designated by the called party. Otherwise, at step 345, the method stops. This method may be repeated whenever the called party receives a call from the calling party.

FIG. 3B illustrates a method for providing media content to a calling party according to an exemplary embodiment. At step 350, responsive to receipt of an indication of a communication from a calling party device, such as device 120, to a called party device, such as device 110, and before termination of the communication from the calling party device and the called party device, a media content sample of media content is transmitted from the media server 140 to the calling party device 120 via the network 130 based on at least one preference of the called party. The media content sample may also be transmitted based on a user preference of the calling party, which may override the preference of the called party. At step 360, a selection is received from the calling party device 120 at the media server 140, indicating whether the calling party desires to download the media content based on the media content sample. At step 370, a determination is made, e.g., by the media server 140, whether the caning party desires to download the media content based on the received selection. If the received selection from the calling party device 120 indicates that the calling party desires to download the media content, the media content is transmitted from the media server 140 to the calling party device 120 via the network 130 or to another device designated by the calling party at step 380. Otherwise, at step 385, the method stops. This method may be repeated whenever the called party receives a call from the calling party.

FIG. 4 is a block diagram of a device for providing media content based on user preferences according to an exemplary embodiment. The device 400 may be implemented in the media server 140. The device 400 includes a processor 410 that receives information, such as data indicating user preferences and requests for media content from the calling device 120 and the called device 110 via I/O Data Ports 420. The I/O Data Ports 420 can be implemented with, e.g., an interface including an antenna or other suitable type of transceiver through which data and signals may be transmitted and received. It should be appreciated that the I/O Data Ports 420 can be used for communications between the devices 110 and 120 via the network 130.

The processor 410 communicates with the memory 430 via, e.g., an address/data bus. The processor 410 can be any commercially available or customer microprocessor. The memory is 430 is representative of the overall hierarchy of memory devices containing the software and data used to implement the functionality of the device 400. The memory 430 can include but is not limited to the following types of devices: processor registers, processor cache, RAM, ROM, PROM, EPROM, EEPROM, flash memory, SRAMD, DRAM other volatile memory forms, and non-volatile, semi-permanent or permanent memory types; for example, tape-based media, optical media, solid state media, hard disks, combinations thereof, and the like.

In addition to the implementations above, various components of the device 400, including the memory 430, processor 410 and I/O Data Ports 420 may be implemented with alternative components. For example, each of these components may be implemented with bio-magnetic, bio-electric, and/or biomechanical devices.

As shown in FIG. 4, the memory 430 may include several categories of software and data used in the device 400, including, applications 440, a database 450, an operating system (OS) 460, and the input/output (I/O) device drivers 470. As will be appreciated by those skilled in the art, the OS 460 may be any operating system for use with a data processing system. The I/O device drivers 470 may include various routines accessed through the OS 460 by the applications 440 to communicate with external devices, and certain memory components. The applications 440 may be stored in the memory 430 and/or in a firmware (not shown) as executable instructions, and can be executed by the processor 410. The applications 440 include various programs that implement the various features of the device 400, including selecting media content samples to provide to calling party/called party devices based on user preferences, providing media content responsive to user selection, etc. The applications performed using data stored in the database 450, along with data, e.g., selections, received via the I/O data ports 420 to provide media content responsive to user requests by the processor 410. The database 450 represents the static and dynamic data used by the applications 440, the OS 460, the I/O device drivers 470 and other software programs that may reside in the memory. The database 450 may include, for example, user preferences and media content.

While the memory 430 is illustrated as residing proximate the processor 410, it should be understood that at least a portion of the memory 430 can be a remotely accessed storage system, for example, a server on a communication network, a remote hard disk drive, a removable storage medium, combinations thereof, and the like. Thus, any of the data, applications, and/or software described above can be stored within the memory 430 and/or accessed via network connections to other data processing systems (not shown) that may include a local area network (LAN), a metropolitan area network (MAN), or a wide area network (WAN), for example.

It should be understood that FIG. 4 and the description above are intended to provide a brief, general description of a suitable environment in which the various aspects of some embodiments of the present disclosure can be implemented. While the description refers to computer-readable instructions, the present disclosure also can be implemented in combination with other program modules and/or as a combination of hardware and software in addition to, or in stead of, computer readable instructions. The term “application,” or variants thereof, is used expansively herein to include routines, program modules, programs, components, data structures, algorithms, and the like. Applications can be implemented on various system configurations, including single-processor or multiprocessor systems, minicomputers, mainframe computers, personal computers, hand-held computing devices, microprocessor-based, programmable consumer electronics, combinations thereof, and the like.

The devices, methods, and computer program products described herein may be implemented in any wireless networks that use exemplary telecommunications standards, such as Global System for Mobile communications (GSM) and Universal Mobile Telecommunications System (UMTS). It should be understood, however, that the devices, methods, and computer program products described herein may alternatively be implemented in wireless networks that use any existing or yet to be developed telecommunications technology. Some examples of other suitable telecommunications technologies include, but are not limited to, networks utilizing Time Division Multiple Access (TDMA), Frequency Division Multiple Access (FDMA), Wideband Code Division Multiple Access (WCDMA), Orthogonal Frequency Division Multiplexing (OFDM), Long Term Evolution (LTE), WIMAX and various other 2G, 2.5G, 3G, 4G, and greater generation technologies. Examples of suitable data bearers include, but are not limited to, General Packet Radio Service (GPRS), Enhanced Data rates for Global Evolution (EDGE), the High-Speed Packet Access (HSPA) protocol family such as, High-Speed Downlink Packet Access (HSDPA), Enhanced Uplink (EUL) or otherwise termed High-Speed Uplink Packet Access (HSUPA), Evolved HSPA (HSPA+), and various other current and future data bearers. Further, the devices, methods and computer products described herein may be implemented using wireline networks or combinations of wireline/wireless networks.

The law does not require and it is economically prohibitive to illustrate and teach every possible embodiment of the present claims. Hence, the above-described embodiments are merely exemplary illustrations of implementations set forth for a clear understanding of the principles of the disclosure. Variations, modifications, and combinations may be made to the above-described embodiments without departing from the scope of the claims. All such variations, modifications, and combinations are included herein by the scope of this disclosure and the following claims.

What is claimed is:

1. A method for offering media content, comprising:
responsive to receipt of an indication of a communication from a first communication device to a second communication device, performing at least one of a first media content offering and a second media content offering, wherein the first media content offering comprises:
transmitting a first media content sample of first media content to the first communication device or the second communication device based on at least one preference of a user of the first communication device or the second communication device; and
receiving a selection from the first communication device or the second communication device indicating whether a user of the first communication device or the second communication device desires to download the first media content based on the first media content sample, wherein if the received selection from the first communication device or the second communication device indicates that the user of the first communication device or the second communication device desires to download the first media content, the first media content is transmitted to the first communication device, the second communication device, or another designated device.

2. The method of claim 1, wherein the second media content offering comprises:
transmitting a second media content sample of second media content to a user of the first communication device or the second communication device based on at least one preference of a user of the first communication device or the second communication device; and
receiving a selection from the first communication device or the second communication device indicating whether the user of the first communication device or the second communication device desires to download the second media content based on the second media content sample, wherein if the received selection from the first communication device or the second communication device indicates that the user of the first communication device or the second communication device desires to download the second media content, the second media content is transmitted to the first communication device, the second communication device, or another designated device.

3. The method of claim 1, wherein at least one of the first media content offering and the second media content offering is provided in substantially real-time upon receipt of an indication of a communication from the first communication device to the second communication device.

4. The method of claim 1, wherein the selected media content is purchased prior to termination of the communication between the first communication device and the second communication device, and the purchased media content is transmitted upon completion of the communication between the first communication device and the second communication device or stored for future transmission.

5. The method of claim 1, further comprising transmitting information for purchasing the selected media content, wherein the information is used to purchase the selected media content after termination of the communication between the first communication device and the second communication device.

6. The method of claim 1, wherein the media content includes at least one of a song, a ring tone, a multi-media package, a book, an event ticket, and other products and services.

7. The method of claim 1, further comprising sending a download notification message to at least one of the first communication device and the second communication device when media content is transmitted to at least one of the first communication device, the second communication device, and the other designated location.

8. The method of claim 1, further comprising:
awarding a credit to the user of the first communication device and billing the user of the second communication device if the user of the second communication device selects to download media content;
awarding a credit to the user of the second communication device and billing the user of the first communication device if the user of the first communication device selects to download the media content; and
crediting the users of the first communication device and the second communication device for recommending media content to at least one other party and billing the at least one other party for downloading recommended media content.

9. A device for offering media content, comprising:
a transceiver for communicating with at least a first communication device and a second communication device;
a memory for storing at least one user preference associated with a user of the first communication device and at least one user preference associated with a user of the second communication device; and
a processor for offering media content based on the stored user preferences, wherein responsive to an indication of a communication from the first communication device to the second communication device, the processor performs at least one of a first media content offering and a second media content offering, wherein the first media content offering comprises:
transmitting a first media content sample of first media content to the second communication device based on at least one preference of a user of the first communication device or the second communication device; and
receiving a selection from the second communication device indicating whether a user of the second communication device desires to download the first media content based on the first media content sample, wherein if the received selection from the second communication device indicates that the user of the second communication device desires to download the first media content, the first media content is transmitted to the second communication device or to another designated device,
and wherein the second media content offering comprises:
transmitting a second media content sample of second media content to the first communication device based on at least one preference of a user of the first communication device or the second communication device; and
receiving a selection from the first communication device indicating whether the user of the first communication device desires to download the second media content based on the second media content sample, wherein if the received selection from the first communication device indicates that the user of the first communication device desires to download the second media content, the second media content is transmitted to the first communication device or to another designated device.

10. The device of claim 9, wherein at least one of the first media content offering and the second media content offering is provided in substantially real-time upon receipt of an indication of a communication from the first communication device to the second communication device.

11. The device of claim 9, wherein the selected media content is purchased prior to termination of the communication between the first communication device and the second communication device, and the purchased selected media content is transmitted upon completion of the communication between the first communication device and the second communication device or stored for future transmission of the purchased media content.

12. The device of claim 9, wherein the processor transmits information for purchasing the selected media content, wherein the information is used to purchase the selected media content after termination of the communication between the first communication device and the second communication device.

13. The device of claim 9, wherein the processor sends a download notification message via the transceiver to at least one of the first communication device and the second communication device when media content is transmitted to at least one of the first communication device, the second communication device, and the other designated location.

14. The device of claim 9, wherein the processor awards a credit to the user of the first communication device and bills the user of the second communication device if the user of the second communication device selects to download the media content associated with the first media content sample, awards a credit to the user of the second communication device and bills the user of the first communication device if the user of the first communication device selects to download the media content associated with the second media content sample, credits the users of the first communication device and the second communication device for recommending media content to at least one other party, and bills the at least one other party for downloading recommended media content.

15. A non-transitory computer readable medium storing instructions which, when executed by a computer, perform a method for offering media content, comprising:
responsive to receipt of an indication of a communication from a first communication device to a second communication device, performing at least one of a first media offering and a second media content offering, wherein the first media content offering comprises:
transmitting a first media content sample of first media content to the first communication device or the second communication device based on at least one preference of a user of the first communication device or the second communication device;
receiving a selection from the first communication device or the second communication device indicating whether a user of the first communication device or the second communication device desires to download the first media content based on the first media content sample; and
if the received selection from the first communication device or the second communication device indicates that the user of the first communicating device or the second communication device desires to download the first media content, transmitting the first media content to the first communication device, the second communication device, or another designated device

16. The non-transitory computer program product of claim 15, wherein the second media content offering comprises:
transmitting a second media content sample of second media content to the first communication device or the second communication device based on at least one preference of a user of the first communication device or the second communication device;
receiving a selection from the first communication device or the second communication device indicating whether the user of the first communication device or the second communication device desires to download the second media content based on the second media content sample; and
if the received selection from the first communication device or the second communication device indicates that the user of the first communication device or the second communication device desires to download the second media content associated, the second media content is transmitted to the first communication device, the second communication device, or another designated device.

17. The non-transitory computer readable medium of claim 16, wherein at least one of the first media content offering and the second media content offering is provided in substantially real-time upon receipt of an indication of a communication from the first communication device to the second communication device.

18. The non-transitory computer readable medium of claim 16, wherein the selected media content is purchased prior to termination of the communication between the first communication device and the second communication device, and the purchased media content is transmitted upon completion of the communication between the first communication device and the second communication device or stored for future transmission, or wherein the selected media content is purchased and transmitted after termination of the communication between the first communication device and the second communication device.

19. The non-transitory computer readable medium of claim 16, wherein the method further comprises sending a download notification message to at least one of the first communication device and the second communication device when media content is delivered to at least one of the first communication device, the second communication device, and the other designated location

20. The non-transitory computer readable medium of claim 15, wherein the method further comprises:
awarding a credit to the user of the first communication device and billing the user of the second communication device if the user of the second communication device selects to download media content;
awarding a credit to the user of the second communication device and billing the user of the first communication device if the user of the first communication device selects to download the media content; and
crediting the users of the first communication device and the second communication device for recommending media content to at least one other party and billing the at least one other party for downloading recommended media content.
